(19) United States
(12) Patent Application Publication
(10) Pub. No.: US 2018/0130267 A1
(43) Pub. Date: May 10, 2018

(54) ONBOARD DIAGNOSTIC SYSTEM AND METHOD

(71) Applicant: Blair Jones, Edmonton (CA)

(72) Inventor: Blair Jones, Edmonton (CA)

(21) Appl. No.: 15/346,670

(22) Filed: Nov. 8, 2016

(51) Int. Cl. G07C 5/00; G07C 5/08

(52) U.S. Cl. CPC G07C 5/008; G07C 5/085

(57) ABSTRACT

An onboard diagnostic system includes an onboard diagnostic sensor, and a mobile application. The onboard diagnostic system is useful for interpreting information from a vehicle's onboard diagnostic system port, and compiling vehicle maintenance information. Further, the onboard diagnostic system provides rust protection to the exterior of a vehicle. Once the onboard diagnostic sensor is plugged in to the vehicle's port, the mobile application is then configured to receive information based on the vehicle's make and model, as well as manufacturer.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of automobiles and more specifically relates to automobile diagnostic code readers.

### 2. Description of Related Art

Many automobiles today have what is known as an onboard diagnostic port. A mechanic can use this port to diagnose problems with the engine and other components by cross referencing the codes provided by the automobile computer with the database provided by the automobile manufacturer. The amount of diagnostic information available via an onboard diagnostic port has varied widely since its introduction in the early 1980s versions of on-board vehicle computers. Early versions of an onboard diagnostic port would simply illuminate a malfunction indicator light if a problem was detected but would not provide any information as to the nature of the problem. Modern OBD implementations use a standardized digital communications port to provide real-time data in addition to a standardized series of diagnostic trouble codes, which allow mechanics to rapidly identify and remedy malfunctions within the vehicle.

A mobile application is a computer program designed to run on smartphones, tablet computers and other mobile devices. Mobile applications were originally offered for general productivity and information retrieval, including email, calendar, contacts, and stock market and weather information. However, public demand and the availability of developer tools drove rapid expansion into other categories, such as mobile games, factory automation, GPS and location-based services, banking, order-tracking, ticket purchases and recently mobile medical applications. The explosion in number and variety of applications made discovery a challenge, which in turn led to the creation of a wide range of review, recommendation, and curation sources, including blogs, magazines, and dedicated online application-discovery services. Many new applications are desirable to provide convenient solutions to the users.

U.S. Publication No. 2011/0012720 to Robert A. Hirschfeld relates to integration of vehicle on-board diagnostics and smart phone sensors. The described integration of vehicle on-board diagnostics and smart phone sensors includes integration between data from the on-board diagnostic system of a vehicle and the sensors contained in a personal communication device or smart phone. The data integration enables improved diagnostic information to be provided to the driver. In addition, data can be distributed to remote systems using the device's network connection for additional analysis and comparison.

### BRIEF SUMMARY OF THE INVENTION

In view of the foregoing disadvantages inherent in the known automobile diagnostic code reader art, the present disclosure provides a novel onboard diagnostic system. The general purpose of the present disclosure, which will be described subsequently in greater detail, is to provide an onboard diagnostic system.

An onboard diagnostic system is disclosed herein. The onboard diagnostic system includes an onboard diagnostic sensor, a wireless transmitter, and a mobile application. The onboard diagnostic sensor connects to virtually any vehicle with an onboard diagnostic system port. The onboard diagnostic sensor connects to a smart phone using a wireless connection so that a user may track and monitor the vehicle.

According to this embodiment, the mobile application may be configured to acquire vehicle location, filter results regarding onboard diagnostic readouts, check the tire pressure measurement system, and provide rust protection to the exterior of a vehicle. The mobile application may be configured to track low and alternately, high fuel economy. Engine temperature and battery voltage may also be displayed, along with a status bar indicator which shows where the fuel economy falls for the vehicle using the onboard diagnostic system.

The onboard diagnostic system may also further track the rotations per minute within the engine as well as providing a date and time stamp when the rotations per minute occur with the top and average speeds, along with the top revolutions per minute and the time spent driving during each event.

The maintenance portion of the mobile application may assist in tracking brake pads, tires, air and fuel filters, oil changes, and suggested times for air conditioning system maintenance as well as other mileage based maintenance checks such as timing belt, transmission, etc. Reminders may also be set for routine maintenance tasks. The onboard diagnostic sensor may be configured to transmit all diagnostic and maintenance information via a wireless connection to a mobile device, and the onboard diagnostic sensor may be easily transferred from one vehicle to another without the use of any special tools or knowledge.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an onboard diagnostic system, constructed and operative according to the teachings of the present disclosure.

FIG. 1 is a perspective view of the onboard diagnostic system during an ‘in-use’ condition, according to an embodiment of the disclosure.

FIG. 2A is a perspective view of the onboard diagnostic system of FIG. 1, according to an embodiment of the present disclosure.

FIG. 2B is a perspective view of the onboard diagnostic system of FIG. 1, according to an embodiment of the present disclosure.

FIG. 3 is a front view of the onboard diagnostic system of FIG. 1, according to an embodiment of the present disclosure.

FIG. 4 is another front view of the onboard diagnostic system of FIG. 1, according to an embodiment of the present disclosure.

FIG. 5 is a flow diagram illustrating a method of use for the onboard diagnostic system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to an automobile diagnostic code reader and more particularly to an onboard diagnostic system as used to improve the rust protection and tracking of a vehicle as well as various mechanical maintenance tasks.

Generally, the onboard diagnostic system is a device that quickly and simply connects to any automobile onboard diagnostic system port. The system can then provide continuous rust protection as well as GPS tracking and tire pressure system monitoring. The system needs no special tools, training or knowledge to use. The onboard diagnostic system sensor is plugged in, and the information is displayed through a smart device with the accompanying mobile application software. Maintenance screens have default mileage for specific tasks which are editable by the user; however these values are able to be reset to the default mileage if preferred.

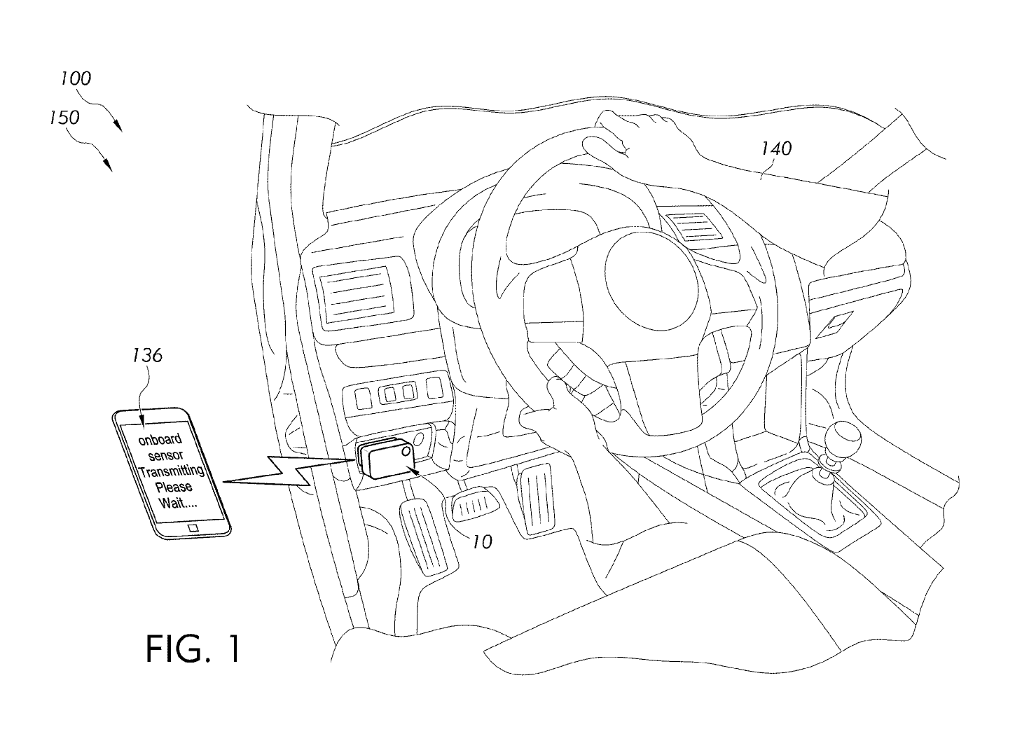

Referring now more specifically to the drawings by numerals of reference, there is shown in FIGS. 1-4, various views of an onboard diagnostic system 100. FIG. 1 shows an onboard diagnostic system 100 during an ‘in-use’ condition 150, according to an embodiment of the present disclosure. Here, the onboard diagnostic system 100 may be beneficial for use by a user 140 to provide rust protection, and track maintenance tasks 115, as well as locate the vehicle position. As illustrated, the onboard diagnostic system 100 may include an onboard diagnostic sensor 110, a wireless transmitter 120, a female connector 130, and a mobile application 136. The onboard diagnostic sensor 110 sends data to the mobile application 136 installed on a smart device; wherein the smart device includes a transceiver embedded in a mobile device housing and configured to communicate over a wireless communication link. This permits the on board diagnostic sensor 110 to send information from the onboard diagnostic system 100 to a smart device so that vehicle location can be acquired, onboard diagnostic readouts can be filtered, the tire pressure management system can be monitored, and so that rust protection can be provided to the exterior of a vehicle.

The mobile application 100 is configured to track low and alternately high fuel economy, engine temperature, rotations per minute, date and time when rotations per minute occur, and total time spent driving. The onboard diagnostic system also tracks when the next oil change is due, when an air filter is ready to be replaced, when brake pads should be checked for wear, when tires should be rotated, and alternately, replaced, when a fuel filter is ready to be replaced, and when an air conditioning system is in need of service. Maintenance records of a vehicle are recorded and the mobile application is configured to set reminders for routine maintenance for that vehicle. The onboard diagnostic sensor is configured to transmit diagnostic information via a wireless internet connection to a mobile device such as a smart phone or tablet, and is transferable between different vehicles. Other maintenance and trackable parameters may be measured and tracked.

According to one embodiment, the onboard diagnostic system 100 may be arranged as a kit 105. In particular, the onboard diagnostic system 100 may further include a set of instructions 155. The instructions 155 may detail functional relationships in relation to the structure of the onboard diagnostic system 100 (such that the onboard diagnostic system 100 can be used, maintained, or the like, in a preferred manner).

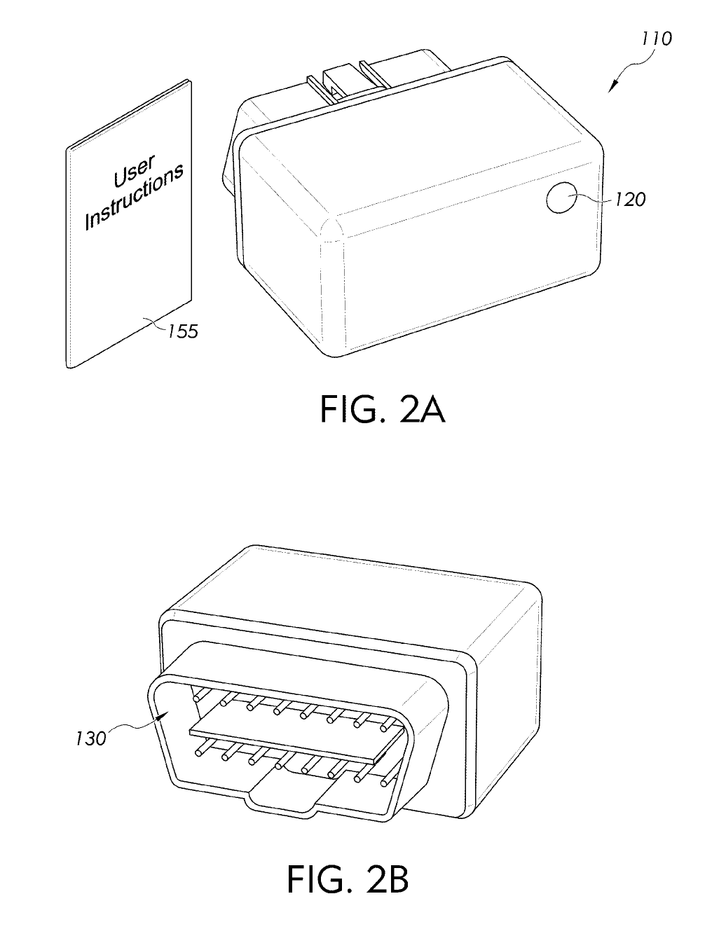

FIGS. 2A & 2B shows the onboard diagnostic system 100 of FIG. 1, according to an embodiment of the present disclosure. As above, the onboard diagnostic system 100 may include an onboard diagnostic sensor 110, a wireless transmitter 120, and a mobile application 136. The onboard diagnostic sensor 110 may include a female connector 130 which interfaces with the male connector 10 inside a vehicle's onboard diagnostic port 30.

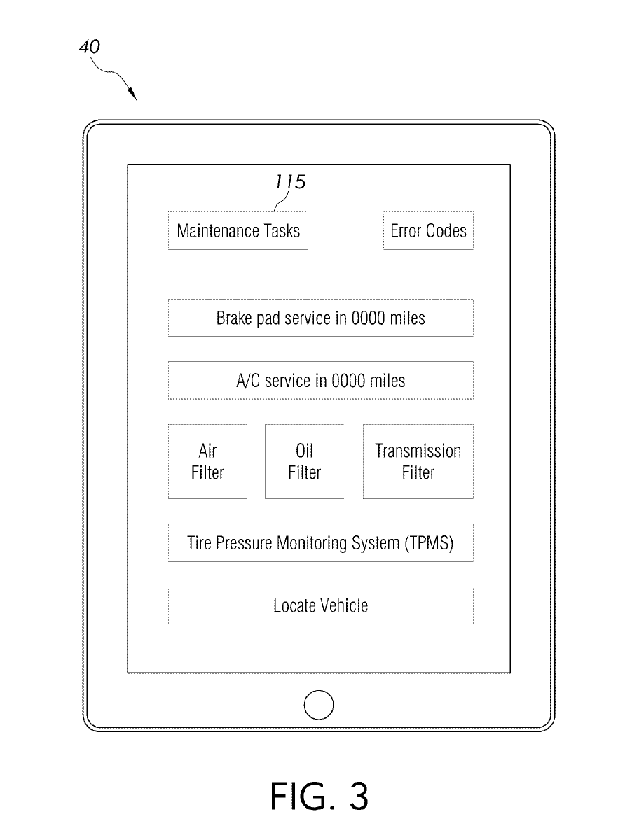

FIG. 3 is a front view of the onboard diagnostic system 100 of FIG. 1, according to an embodiment of the present disclosure. The mobile application 136 is in use on a smart tablet 40, where information may be displayed regarding any error codes located with the onboard diagnostic sensor 110. Information may also be displayed regarding required maintenance services.

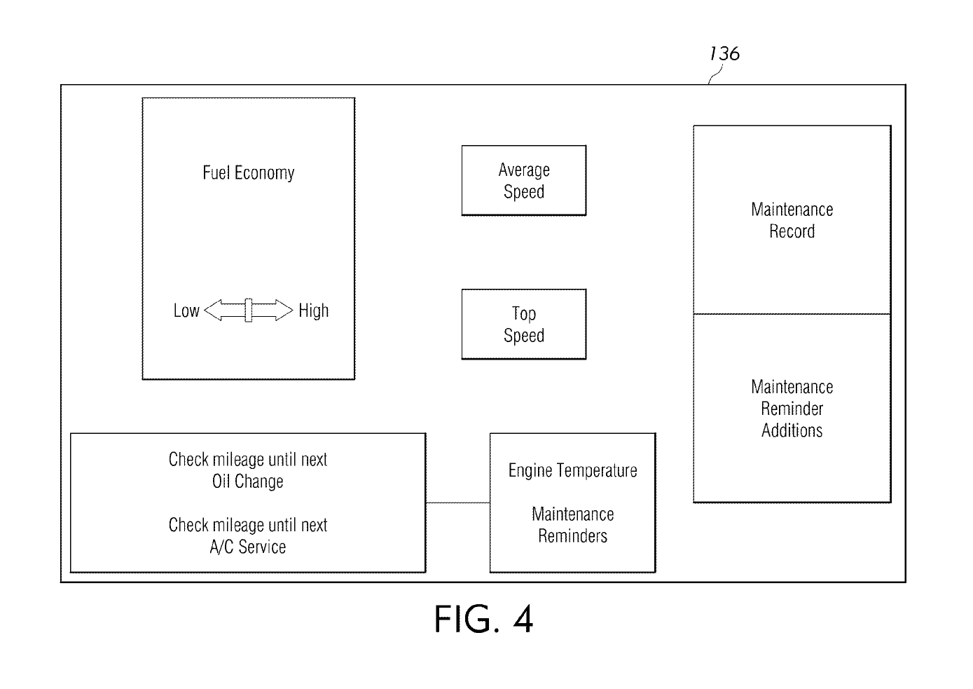

FIG. 4 is another front view of the onboard diagnostic system 100 of FIG. 1, according to an embodiment of the present disclosure. Various mobile application 136 information is displayed with approximate time frames for engine usage and diagnostic maintenance information.

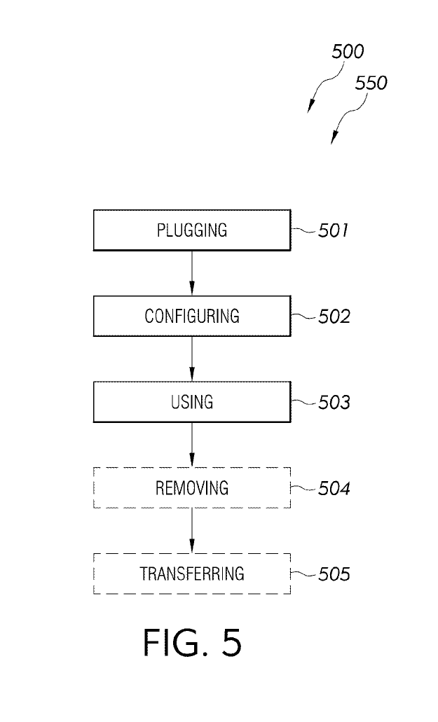

FIG. 5 is a flow diagram illustrating a method for using the onboard diagnostic system 100, according to an embodiment of the present disclosure. In particular, the method for the onboard diagnostic system 500 may include one or more components or features of the onboard diagnostic system 100 as described above. As illustrated, the method for the onboard diagnostic system 500 may include the steps of: step one 501, plugging the onboard diagnostic system in to a vehicle's onboard diagnostic system port; step two 502, configuring the mobile application to communicate with the data sent from the onboard diagnostic system; step three 503, using the mobile application to interpret the information sent from the onboard diagnostic system; step four 504, removing the onboard diagnostic system; and step five 505, transferring the onboard diagnostic system to another vehicle.

It should be noted that steps 504, and 505 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for using the onboard diagnostic sensor 110 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An onboard diagnostic system, the system comprising:
an onboard diagnostic sensor having;
a wireless transmitter; and
a female connector plugged into a vehicle onboard diagnostic system output port;
a mobile application;
wherein the onboard diagnostic sensor sends data to the mobile application installed on a smart phone;
wherein the smart phone includes a transceiver embedded in a mobile device housing and is configured to communicate over a wireless communication link;
a memory embedded in the mobile device housing, and is configured to store a mobile application; and
wherein the mobile application is configured to provide data of vehicle location, filter results regarding onboard diagnostic readouts, communicate with a tire pressure measurement system, and provide rust protection to an exterior of a vehicle.

2. The system of claim 1, wherein the mobile application is configured to remotely track low and alternately, high fuel economy.

3. The system of claim 1, wherein the mobile application is configured to track rotations per minute.

4. The system of claim 3, wherein the mobile application is configured to track date and time when said rotations per minute occur.

5. The system of claim 1, wherein the mobile application is configured to track total time spent driving.

6. The system of claim 1, wherein the mobile application is configured to track when a next oil change is due.

7. The system of claim 1, wherein the mobile application is configured to track when an air filter is ready to be replaced.

8. The system of claim 1, wherein the mobile application is configured to track when brake pads should be checked for wear.

9. The system of claim 1, wherein the mobile application is configured to track when tires should be rotated, and alternately, replaced.

10. The system of claim 1, wherein the mobile application is configured to track when a fuel filter is ready to be replaced.

11. The system of claim 1, wherein the mobile application is configured to track when an air conditioning system is in need of service.

12. The system of claim 1, wherein the mobile application is configured to track engine temperature.

13. The system of claim 1, wherein the onboard diagnostic sensor is configured to transmit diagnostic information via a wireless connection to a mobile device.

14. The system of claim 1, wherein the onboard diagnostic sensor is transferable between different said vehicles.

15. The system of claim 1, wherein the mobile application is configured to maintain a maintenance record of said vehicle.

16. The system of claim 1, wherein the mobile application is configured to set reminders for routine maintenance.

17. An onboard diagnostic system, the system comprising:
an onboard diagnostic sensor having;
a wireless transmitter; and
a female connector plugged into a vehicle onboard diagnostic system output port;
a mobile application; wherein the onboard diagnostic sensor sends data to the mobile application installed on a smart phone; wherein the smart phone includes a transceiver embedded in a mobile device housing and configured to communicate over a wireless communication link;
a memory embedded in the mobile device housing, and configured to store a mobile application, and
the mobile application configured to acquire vehicle location, filter results regarding onboard diagnostic readouts, communicate with a tire pressure measurement system, and provide rust protection to the exterior of a vehicle;
wherein the mobile application is configured to track low and alternately high fuel economy, engine temperature, rotations per minute, date and time when rotations per minute occur, total time spent driving, when next oil change is due, when an air filter is ready to be replaced, when brake pads should be checked for wear, when tires should be rotated, and alternately, replaced, when a fuel filter is ready to be replaced, when an air conditioning system is in need of service, and maintain a maintenance record of a vehicle; and is configured to set reminders for routine maintenance; and
wherein the onboard diagnostic sensor is configured to transmit diagnostic information via a wireless internet connection to a mobile device, and is transferable between different said vehicles.

18. The system of claim 17, further comprising set of instructions; and
wherein the system is arranged as a kit.

19. A method of use for the onboard diagnostic system, the method comprising the steps of:
plugging the onboard diagnostic system into a vehicle's onboard diagnostic system port;
configuring a mobile application to communicate with data sent from the onboard diagnostic system; and
using the mobile application to interpret the data sent from the onboard diagnostic system.

20. The method of claim 19, further comprising the steps of:
removing the onboard diagnostic system; and
transferring the onboard diagnostic system to another vehicle.
